(19) United States
(12) Patent Application Publication
(10) Pub. No.: US 2007/0065261 A1
(43) Pub. Date: Mar. 22, 2007

(54) Apparatus and system for densifying and transporting bulk materials, and related methods

(76) Inventors: Arthur Nelson Chambers, High River (CA); Stanley Evan Pedersen, Vernon (CA); Gordon Ian Robert Greig, Vernon (CA)

Correspondence Address: Ralph A. Dowell of DOWELL & DOWELL P.C., 2111 Eisenhower Ave, Suite 406, Alexandria, VA, 22314, US

(21) Appl. No.: 11/218,734

(22) Filed: Sep. 6, 2005

(51) Int. Cl. B60P 1/00

(52) U.S. Cl. 414/435

(57) ABSTRACT

An apparatus for densifying and transporting bulk materials, the apparatus comprising a container for holding bulk materials, a wheeled chassis for transporting the container along a roadway, and a shaker, mounted on the chassis and transportable therewith, for shaking the container while the container is being loaded, to increase packing density of bulk materials in the container. A related transportation system and methods are also provided.

### BACKGROUND OF THE INVENTION

1. Field of Invention

This invention relates generally to the field of transportation, and more particularly, to apparatuses, methods and systems for densifying and transporting bulk materials.

2. Related Art

Various vehicles, including trains and trucks, are commonly used to transport bulk materials such as powder, grain, sawdust and wood chips, for example. For such vehicles, it is desirable to maximize the amount of bulk materials that are transported per trip while staying within legally permissible size and weight limits for the vehicle. For example, various laws and regulations constrain the maximum weight of cargo that may be hauled by a tractor and semi-trailer assembly along a public roadway. In addition, regulations also restrict the maximum size of the semi-trailer(s) that may be hauled by one tractor.

Thus, various attempts have been made to maximize the load-carrying capacity of vehicles designed for transporting bulk materials. Transportation systems are often built to the maximum sizes in length, height and depth permissible by law. For instance, wood chips and other wood residuals are typically hauled in tractor-towable trailers with containers which are specially designed to maximize the amount of wood chips that are transported. First, the trailers typically use cargo containers which are made of fastened-together aluminum strips, rather than steel, to reduce the overall weight of the trailers, in order to preserve as much of the permissible weight limit as possible for carrying wood chips and wood residue. Second, container capacity is increased by including a lowered drop bed portion adjacent the wheels of a trailer in order to increase the height of the trailer. Furthermore, first and second trailers with respective containers mounted thereon may be assembled together to be hauled in tandem behind a tractor. Trailer assemblies of this design may be called B-Trains or SuperTrains, with the first and second trailers being referred to as “A-box” and “B-box” respectively. Such trailers are manufactured, for instance, by TY-CROP Manufacturing Ltd. of Rosedale, British Columbia, Canada, VOX 1X0, phone number 604-794-7078.

Despite the aforementioned attempts to increase carrying capacity, in some cases it remains possible to load a maximally-sized transportation system completely full in terms of volume without reaching the maximum weight limits which are legally permissible to transport. That is, it is possible for a vehicle to “volume out” before “weighing out”. This problem is especially acute in the case of relatively light and/or irregularly-shaped bulk materials, such as wood chips. Such loads may retain air spaces in between bulk material particles loaded into a container. It is desirable to overcome this problem to increase the carrying capacity of such transportation systems.

Various shakers and vibrators have been used in the past attempt to vibrate loads in order to reduce air spaces between bulk material particles to increase carrying capacity. These shakers and vibrators may be unsuitable for the types of vehicles that are used on roadways for transporting bulk materials such as wood chips. To take one example, rail car shakers are installed adjacent to railroad tracks and are used to shake an entire rail car to cause bulk materials held within to be compacted. Rail car shakers are heavy, external machines which are not transportable with the vehicle and are ordinarily installed at a fixed location, such as a railway yard, thus rail car shakers are not convenient for use with road-based transportation systems such as SuperTrain truck assemblies. In the railway industry, smaller vibrators may be attached to the walls of rail cars, to compact bulk materials therein. However, such vibrators may be unsafe to use on containers such as those described above for hauling wood chips because these containers are typically made of aluminum which is not designed to withstand the stress of vibration. The walls of such a container are typically comprised of strips of aluminum material joined together by fasteners such as rivets to form an enclosure for carrying the bulk materials. Attaching a vibrator directly to such a container would likely stress and eventually damage the fasteners thereby creating a risk of the entire container rupturing. Thus, a different approach is needed.

Various after-market “vibrators” are available for use in unloading applications. For example, vibrators such as the Phillips Temro 12 Volt Dump Body Vibrator Part 800-0875, available from Gregg Distributors of Edmonton, Alberta, Canada or Hayworth Equipment Sales of Acheson, Alberta, Canada, are often attached to the underside of the tiltable bed of a dump truck, in order to facilitate unloading of materials in the bed. To dislodge a frozen load, for instance, the dump truck operator may actuate the vibrator for 15 seconds or so while the dump truck bed is being tilted. However, such vibrators are not suitable for installation on containers comprised of aluminum strip material joined by fasteners. More generally, it would not be prudent to attach a vibrator directly to the cargo containers of many transportation systems, since they are built far less sturdily than a dump truck bed. Moreover, the motors used in many of these vibrators are “starter-type” motors which are generally unsuitable for applications that require sustained operation for more than, say, 30 seconds. Such motors draw excessive amounts of power as well.

Another problem frequently encountered in connection with the loading of bulk materials is that bulk materials do not always readily spread to all the extremities of the cargo container being loaded. For example, if wood chips are being loaded from an overhead chute into a container having an inlet opening in its top portion, the wood chips may pile up in the container at a point underneath the chute, rather than spreading to the far corners of the container. Failing to completely fill all the corners of the container effectively reduces the carrying capacity of the container. To address this problem, an operator of the vehicle often climbs up on top of the trailer to “groom” the crown of the load so as to cause it to fill the unfilled portions of the container. However, grooming the load in this manner is time-consuming and dangerous since the operator might fall.

An ASG Loading SysteM™ presented and described herein addresses the above problems and other needs in the field of bulk material transport.

### SUMMARY OF THE INVENTION

In accordance with one aspect of the invention, there is provided an apparatus for densifying and transporting bulk materials. The apparatus includes a container for holding bulk materials, a wheeled chassis for transporting the container along a roadway, and a shaker, mounted on the wheeled chassis and transportable therewith, for shaking the container while the container is being loaded, to increase packing density of bulk materials in the container.

The shaker may be permanently connected to the chassis.

The chassis may include first and second spaced apart longitudinal beams, disposed generally parallel to a longitudinal axis of the chassis.

The shaker may be operably mounted on at least one of the first and second longitudinal beams.

The chassis may further include a transverse beam extending between the first and second longitudinal beams and the shaker may be operably mounted on the transverse beam.

The apparatus may include a plate extending from the transverse beam, the shaker being operably mounted on the plate. A gusset may be provided for reinforcing the plate.

The apparatus may include a mount, affixed to the chassis, operably configured to mount the shaker to the chassis, and may further include a reinforcing member for reinforcing the mount.

The container may include a plurality of sheet material panels and fasteners fastening the plurality of sheet material panels together to form an enclosure.

The container may include top, bottom, front, rear and first and second side portions, the top portion having an inlet for receiving bulk materials to be loaded into the container, and the rear portion having an outlet for discharging the bulk materials from the container.

The container may include an inner floor, a substantial part of which may include at least one generally planar floor section having a longitudinal axis generally parallel to a longitudinal axis of the chassis.

The inner floor may be continuous.

The apparatus may include a hitch on the front portion of the container for hitching the apparatus to a vehicle.

The container may include a drop-bed portion, between the front and rear portions, the chassis directly supporting the rear portion but not the drop-bed portion.

The apparatus may include at least one connector for receiving power from a power supply, for actuating the shaker.

At least one connector may be releasably connectable to a complementary connector on a vehicle, to facilitate separation of the apparatus from the vehicle.

The apparatus may further include a first control operably configured to selectively cause the power supply to supply power through the at least one connector to the shaker when the at least one connector is receiving the power for actuating the shaker.

The first control may be located on the container.

The container may have a recess and the first control may be located in the recess.

The control may include an electrical switch.

In accordance with another aspect of the invention, there is provided a system for densifying and transporting bulk materials in a container. The system includes the aforesaid apparatus and a power supply, a second control, and a complementary connector, complementary to the at least one connector. The second control is operably configured to selectively cause the power supply to supply power to the complementary connector for receipt by the at least one connector for actuating the shaker.

The system may further include a signaling device operably configured to provide a signal to an operator when power for actuating the shaker is being supplied to the complementary connector.

The second control may be located in a cab of a vehicle operable to haul the apparatus.

The signaling device may be mounted on a vehicle operable to haul the apparatus.

The shaker may include a rotatable shaft, an eccentric weight mounted on the shaft and a motor operable to rotate the shaft in response to power received from the power supply.

The power supply may be selected from the group consisting of an electrical power supply, a hydraulic power supply, and a pneumatic power supply.

In accordance with another aspect of the invention, there is provided a method of manufacturing an apparatus for densifying and transporting bulk materials. The method involves operably connecting a shaker to a wheeled chassis on which is mounted a container formed of individual sheet material panels fastened together, for carrying bulk materials. The method further involves operably connecting a power controller to at least one of the chassis and the container in a location accessible by an operator, and operably connecting the power controller to at least one releasable connector for receiving power from a power supply associated with a vehicle operable to the apparatus. The method further involves operably connecting the power controller to the shaker to facilitate operator control of power supplied to the shaker to permit the operator to control the power to cause the shaker to shake the chassis and the container mounted thereto, to increase packing density of bulk material in the container.

Connecting the shaker to the wheeled chassis may involve operably connecting the shaker to at least one of a longitudinal or transverse beam of the chassis.

Connecting the shaker to the wheeled chassis may involve welding a base of the shaker to a mount supported by a transverse beam of the chassis.

The method may also involve installing an additional connector on the apparatus, the additional connector being operable to receive at least some power from the at least one connector and to supply the at least some power to a connector connected thereto for powering a second shaker on a second apparatus.

In accordance with another aspect of the invention, there is provided an apparatus for densifying and transporting bulk materials, the apparatus including holding means for holding bulk materials, transporting means for transporting the holding means along a roadway, and shaking means, mounted on the transporting means, for shaking the transporting means to impart shaking to the holding means while the holding means is being loaded, to increase packing density of bulk materials held by the holding means.

In accordance with another aspect of the invention, there is provided a method of densifying bulk materials for transport, the method involving causing a container, operable to hold bulk materials, to shake, in response to actuation of a shaker mounted on a wheeled chassis on which the container is mounted, while causing bulk materials to be received in the container.

The method may involve facilitating receipt and storage of the bulk materials in a drop bed of the container, wherein the drop bed is located adjacent wheels of the wheeled chassis.

Causing the container to shake may involve controlling power supplied to the shaker.

Controlling power supplied to the shaker may involve actuating a switch to selectively supply power to the shaker.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a side view of a system for densifying and transporting bulk materials according to an embodiment of the invention, the system including first and second apparatuses shown being towed in tandem behind a towing vehicle;

FIG. 2 is a simplified perspective view of a chassis of the first apparatus shown in FIG. 1, showing a shaker of the first apparatus connected to a transverse or longitudinal beam of the chassis frame;

FIG. 3 is a view along lines III-III in FIG. 2, showing a side view of a shaker installed on the transverse beam of the chassis frame shown in FIG. 2;

FIG. 4 is a cross sectional view along the lines IV-IV in FIG. 2, showing a side view of a shaker connected to a longitudinal beam of the chassis frame shown in FIG. 2 according to a second embodiment of the first apparatus shown in FIG. 1;

FIG. 5 is a top view of an embodiment of a shaker shown in FIGS. 2 to 4;

FIG. 6 is a top view of the system shown in FIG. 1 illustrating exemplary locations of the shakers shown in FIGS. 2 to 4;

FIG. 7 is a schematic diagram of an electrical system of the system shown in FIG. 1;

FIG. 8 is a flowchart illustrating a method of manufacturing the first or second apparatus shown in FIG. 1; and

FIG. 9 is a flow chart illustrating a method of densifying bulk materials for transport in the system shown in FIG. 1.

### DETAILED DESCRIPTION

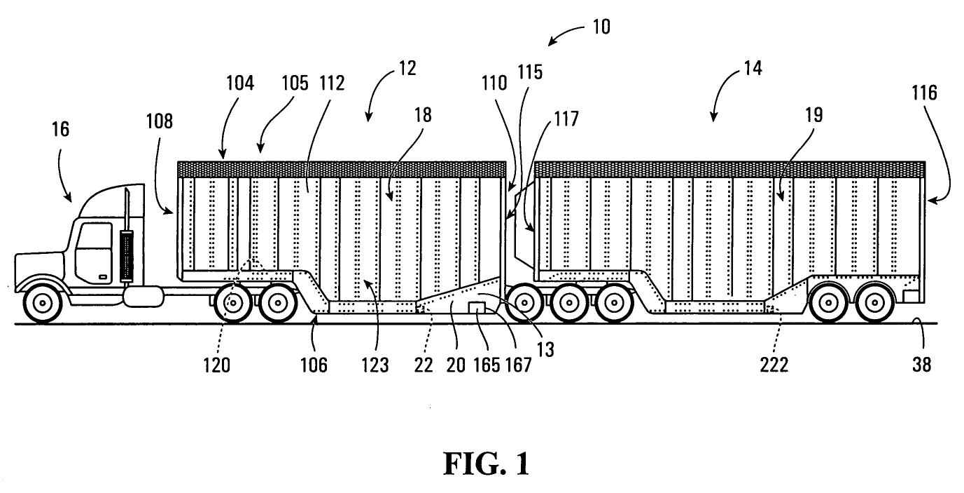

Referring to FIG. 1, a system for densifying and transporting bulk materials is shown generally at 10. In this embodiment, the system includes a first apparatus for densifying and transporting bulk materials, shown generally at 12, and a second apparatus for densifying and transporting bulk materials, shown generally at 14. In addition, the system 10 includes a towing vehicle such as a tractor, shown generally at 16, connected to the first apparatus 12. The second apparatus 14 is connected to the first apparatus 12. While the system 10 has been shown with two apparatuses 12 and 14, it will be appreciated that the system may be used with only one apparatus such as apparatus 12, or the apparatus 14, for example. In the embodiment shown, the tractor is operable to tow both apparatuses 12 and 14 at the same time.

The first apparatus 12 includes a container 18 for holding bulk materials. In this embodiment, the container includes a plurality of sheet material panels fastened together by fasteners, such as rivets, to form an enclosure. The apparatus 12 further includes a wheeled chassis, shown generally at 20, for transporting the container 18 along a roadway 38. The chassis 12 includes a frame 13 to which the container 18 is permanently connected. The apparatus 12 further includes a shaker 22, mounted on the wheeled chassis 20 and transportable therewith, for shaking the container 18 while the container is being loaded, to increase packing density of bulk materials in the container.

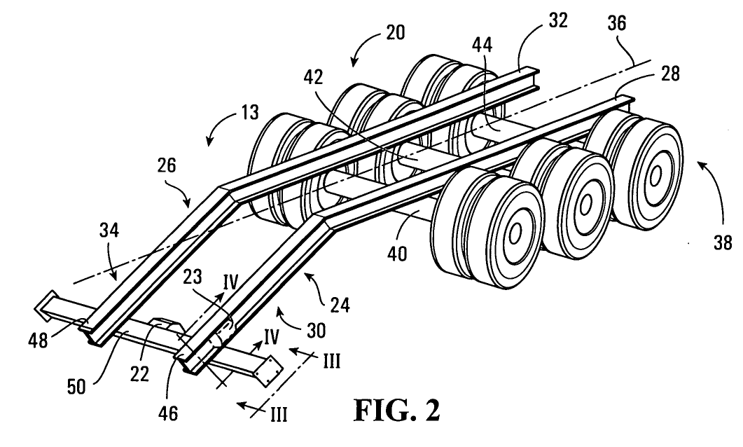

Referring to FIG. 2, the chassis 20 of the first apparatus 12 is shown in greater detail. (The chassis of the second apparatus 14 is similar.) The chassis 20 is shown without extraneous parts. For example, suspension, brakes, and other parts associated with the chassis, are omitted in this figure. In this embodiment, the chassis 20 includes first and second spaced apart longitudinal beams 24 and 26, each of which is formed of a steel I-beam. The first longitudinal beam 24 has a horizontally disposed portion, shown generally at 28, and a downwardly sloping angularly disposed (i.e., angled) portion, shown generally at 30. The second longitudinal beam 26 also has a generally horizontal portion 32 and a downwardly sloping angled portion 34. The first and second longitudinal beams 24 and 26 are disposed generally parallel to each other such that the chassis 20 has a longitudinal axis 36. The horizontal portions 28 and 32 of the first and second longitudinal beams 24 and 26 are disposed generally parallel to a roadway, shown generally at 38, over which the apparatus 12 may be towed by the tractor vehicle 16 shown in FIG. 1. Referring back to FIG. 2, the chassis 20 further includes a plurality of wheeled axles shown generally at 40, 42, and 44, enabling the chassis to be towed over the roadway surface 38.

Still referring to FIG. 2, the angled portions 30 and 34 of the first and second longitudinal beams have distal end portions 46 and 48, respectively. Between these distal end portions, a transverse beam 50, which is sometimes referred to as the “reaction beam”, is secured to extend between the first and second longitudinal beams 24 and 26. In this embodiment, the transverse beam 50 also extends out to the edge of the apparatus 12 and the container 18 is bolted to end plates of the transverse beam 50. In one embodiment, the shaker 22 is mounted to the transverse beam 50.

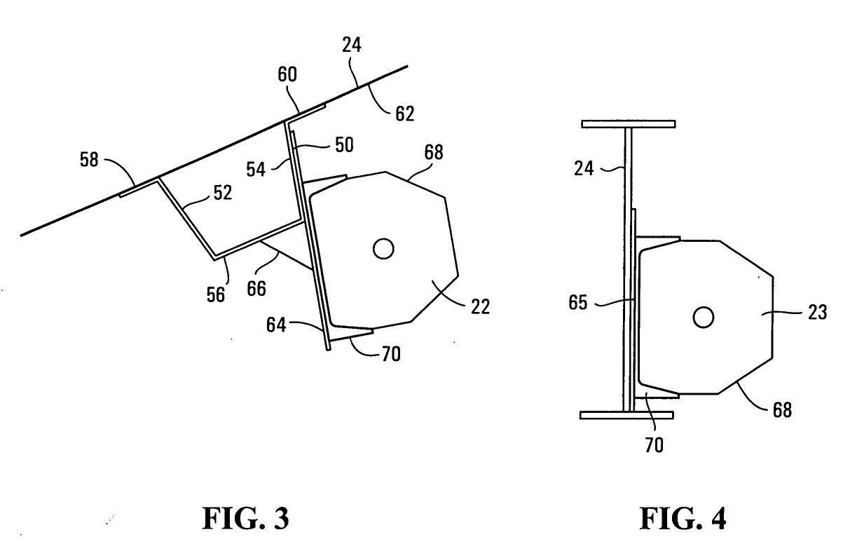

Referring to FIG. 3, the shaker 22 is shown mounted to the transverse beam 50, in greater detail. In this embodiment, the transverse beam 50 has a trapezoidal shape with first and second generally flat planar leg portions 52 and 54 joined together by a cross portion 56. The first and second leg portions 52 and 54 have first and second securing portions 58 and 60, respectively, which are configured to lie in a common plane for connection to the under surfaces 62 of the longitudinal beams 24 or 26. To the second leg 54, there is connected a flat plate, shown generally at 64. A gusset 66 is connected between the cross portion 56 of the transverse beam 50 and the plate 64 to reinforce and rigidly secure the plate to the transverse beam. The shaker 22 includes an enclosure 68 and a base 70 which, in this embodiment, includes an 8 inch “C-shaped” channel. The base 70 is secured to the plate 64 to permanently affix the shaker 22 to the chassis 20. Effectively, the plate 64 is used as a mount for the shaker 22. In this embodiment, the base 70 of the shaker 22 is welded to the plate 64, and the plate is welded to the transverse beam 50. The plate 64 increases the amount of surface area for welding the base 70 of the shaker 22, thereby improving its connection with the transverse beam 50. Mounting the shaker 22 on the second (rear) leg 54 of the transverse beam 50 helps to ensure adequate clearance to the roadway 38 and also shelters the shaker somewhat from roadway debris.

Referring to FIG. 4, a shaker 23 (analogous to shaker 22) is shown mounted to the longitudinal beam (24 or 26) according to a second embodiment of the apparatus 12. In this embodiment, the base 70 of the shaker 23 is connected to the web of the longitudinal beam 24 by welding the base 70 to a plate 65, which is itself welded to the web of the longitudinal beam 24, for example. In some embodiments, the shaker 23 could be mounted directly to the longitudinal beam 24, however, in this embodiment, the plate 65 is effectively used as a mount for the shaker. Using the plate 65 to mount the shaker 23 also facilitates easy and secure connection of the shaker to the beam 24.

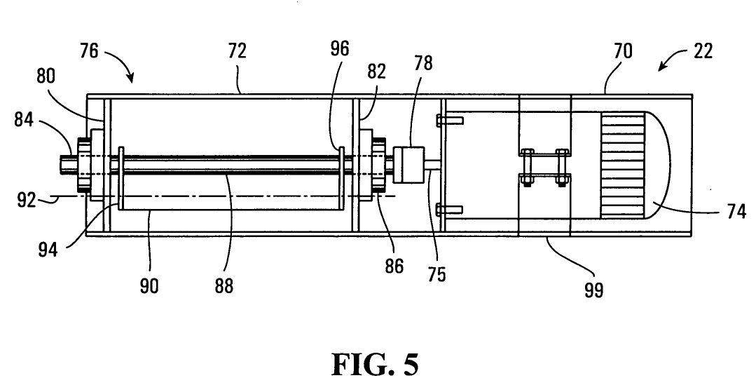

Referring now to FIG. 5, an embodiment of the shaker 22 is shown in greater detail. The shaker 22 includes a motor 74 mounted to the base 70. The motor 74 has a shaft 75 disposed generally parallel to a longitudinal axis of the base 70 and is coupled to an eccentric weight system, shown generally at 76, through a coupler 78. The eccentric weight assembly 76 includes first and second support plates 80 and 82 to which are connected bearings 84 and 86. A shaft 88 is supported for rotation by the bearings 84 and 86 and is connected to the shaft 75 for rotation therewith.

A weight 90 is secured eccentrically to the shaft 88. In this embodiment, the weight 90 includes a length of solid square metal stock approximately 2×2 inches in size and weighing approximately 16 lbs. The weight 90 is secured to the shaft 88 by first and second end plates 94 and 96 such that a centre line 92 through the centre of mass of the weight 90 is parallel and spaced apart from the centre line of the shaft. When the shaft 88 is rotated by the motor 78, the eccentric weight 90 rotates with the shaft and creates a vibration or shaking motion that is transferred to the support plates 80 and 82, the base 70, and, ultimately, to the chassis 20.

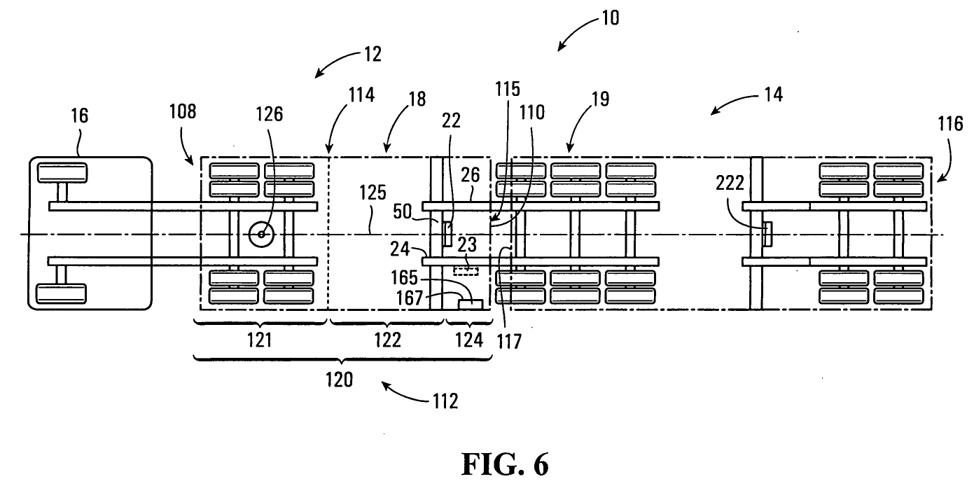

The motor 74 is mounted to the C-channel base 70 by mounting straps 99. In this embodiment, the motor comprises a 1 HP, 12V DC motor nominally rotating at 1800 RPM and drawing a maximum of about 85 amps when accelerating and drawing about 35 amps when operating in steady state. In this embodiment, the motor 74 comprises a custom Baldor Industrial 12V DC Motor, Type PM3435P, Cat. No. CDP3445-V12, capable of operating for 30 minutes or longer without overheating, in contrast to the starter-type motors which are typically used in vibrators intended for unloading operations on dump trucks, for example. The use of such a design is significant because loading both apparatuses 12 and 14 of the system 10 may take 20-30 minutes when loading the containers 18 and 19 from an overhead chute, or even longer, when a loader is used to deposit wood chips in the containers. Referring now to FIGS. 1 and 6, the container 18 will now be generally described. The container 18 comprises a top portion shown generally at 104, a bottom portion shown generally at 106, a front portion shown generally at 108, a rear portion shown generally at 110, and first and second side portions 112 and 114, respectively. The container 18 includes a hitch 126 on the front portion 108 of the container for hitching the apparatus 12 to the vehicle 16 for towing the apparatus.

The top portion 104 includes a top inlet opening 105 for receiving bulk materials to be loaded into the container 18, and the rear portion 110 has an outlet opening 115 for discharging the bulk materials from the container. The inlet opening 105 is typically covered by a tarpaulin during transport to enclose the bulk materials held in the container 18. The rear portion 110 includes outlet doors (not shown) operable to be opened to facilitate unloading through the outlet opening 115. When opened, the outlet doors of the apparatus 12 interface with a front inlet opening 117 on a front portion of the second container 19, effectively bridging the gap between the apparatuses 12 and 14, to provide a channel between the first container 18 and the second container 19. Bulk materials are unloaded from the system 10 by fastening the entire system onto a hydraulic ramp which then tilts the entire system at a sharp angle to allow bulk materials held in the first container 18 to be discharged through the outlet opening 115, into the second container 19 and through an outlet opening 116 in the second container.

Referring to FIG. 6, the container 18 includes an inner floor 120 for supporting the bulk materials loaded in the container 18. The inner floor 120 in this embodiment is continuous and thus prevents any of the bulk materials from being discharged therethrough. The inner floor 120 in this embodiment includes a number of generally planar floor sections, including a first floor section 121, a second floor section 122, and a third floor section 124. The first floor section 121 is located in the front portion 108 of the apparatus 12, the third floor section 124 is located in the rear portion 110, and the second floor section 122 is located between the first and third floor sections 121 and 124. The floor sections 121, 122, and 124 may not be perfectly flat since they may include embedded longitudinal members (not shown) arranged generally in a plane to reinforce the floor sections. Nevertheless, in this embodiment, the first and second floor sections 121 and 122 have a generally planar profile that is generally parallel to the longitudinal axis 125 of the system 10. Referring back to FIG. 1, the depth of the container 18 drops suddenly between the first and second floor portions 121 and 122 such that the second floor section 122 effectively comprises a drop bed portion 123 between the front and rear portions 108 and 110 of the apparatus 12.

In this embodiment, the third floor section 124 also has a planar profile and slopes gradually upward to facilitate discharge of bulk materials from the outlet opening 115 of the first apparatus 12 into the front inlet opening 117 of the second apparatus 14. It will be noted that the chassis 20 generally supports the rear portion 110 of the container 18 but not the drop bed portion. The upwardly sloping third floor section 124 is supported by the angled portion (30, 34 in FIG. 2) of the underlying chassis 20.

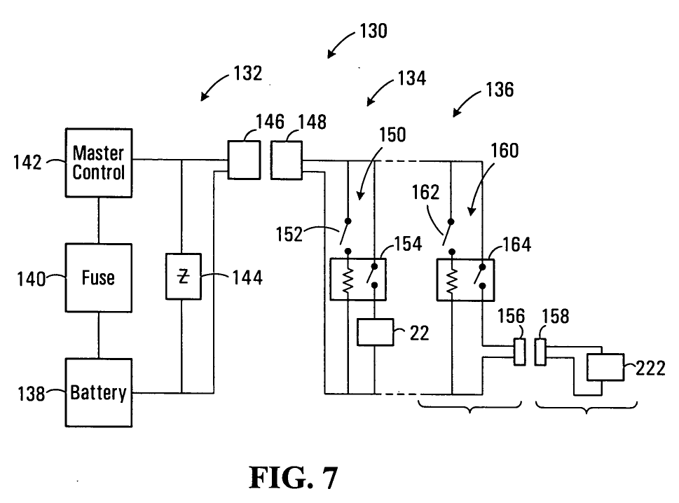

Referring to FIG. 7, a circuit for powering the shakers 22 and 222 on the first and second apparatuses 12 and 14 shown in FIG. 1, is shown generally at 130. In this embodiment, the circuit includes a power supply portion 132, a first distribution portion 134 associated with the first apparatus 12 and a second distribution portion 136 associated with the second apparatus 14. The power supply portion 132 is located on the towing vehicle 16. In this embodiment, the power supply portion 132 includes a battery 138, which may be a battery of the vehicle 16 or a second, deep cycle battery, for example. The battery 138 is connected through a fuse 140 to a master control 142 which may include a high current switch, for example. The master control 142 is further connected to an indicator device, which in this embodiment includes a buzzer 144, that is actuated when the master control is placed in an “on” position. The power supply portion 132 further includes a connector 146 which may be located at a rear portion of the towing vehicle 16 for connection to a complementary connector 148 of the first distribution circuit 134 on the first apparatus 12. The connector 146 is supplied with power through the master control 142 such that when the master control is in the “on” position, power is available to the first distribution circuit 134 through the connector 146.

The first distribution circuit 134 includes the complementary connector 148 which is operable to receive power through the connector 146 from the power supply circuit 132 for actuating the first shaker 22. The connectors 146 and 148 are releasable, to facilitate separation of the apparatus 12 from the towing vehicle 16. The distribution circuit 134 further includes a first control shown generally at 150 operably configured to selectively cause power received at the connector 148 to be supplied to the first shaker 22. In this embodiment, the first control 150 includes a toggle switch 152 and a solenoid 154. The toggle switch 152 controls the solenoid 154 such that when the toggle switch is closed, the solenoid 154 is energized to cause power to be received from the connector 148 and supplied to the first shaker 22. The toggle switch 152 may be located on the first apparatus 12 in a convenient location to facilitate easy user access and operation to enable a user standing beside the apparatus to actuate the toggle switch 152 to cause the shaker 22 to begin shaking when the container 18 of the first apparatus 12 is being loaded.

In this embodiment, the circuit 130 may optionally include a second power distribution circuit portion 136 including a second connector 156 operable to receive at least some power from the connector 148. The second power distribution portion 136 is similar to the first power distribution portion 134 in that it includes a control 160, which in this embodiment includes a toggle switch 162, and a solenoid 164. When the second toggle switch 162 is closed, the solenoid 164 is energized thereby causing power to be supplied from the connector 148 to the connector 156. The second connector 156 may be located near the rear portion 110 of the apparatus 12 to facilitate connection to a complementary connector 158 of the second power distribution portion 136 on a front portion of the apparatus 14, for example. The connectors 156 and 158 are releasably connectable such that the second apparatus 14 may be separated from the first apparatus 12 if necessary.

The first and second controls 150 and 160, and in particular the switches 152 and 162 thereof, may be mounted on the container 18 in a recess 165 in a wall of the first container 18. In one embodiment, the first and second controls 150 and 160 are mounted in a control box 167 in FIG. 1 embedded in a side wall of the container 18 such that the controls 150 and 160, and more particularly the switches 152 and 162 thereof, are accessible to the operator but are protected from the elements by a cover of the control box. The control box 167 may be lockable to prevent unauthorized access to the controls 150 and 160.

Although the power supply circuit 130 of this embodiment has been described as an electrical system, it will be appreciated that the power supply assembly could be alternately implemented as a hydraulic or pneumatic system, for example.

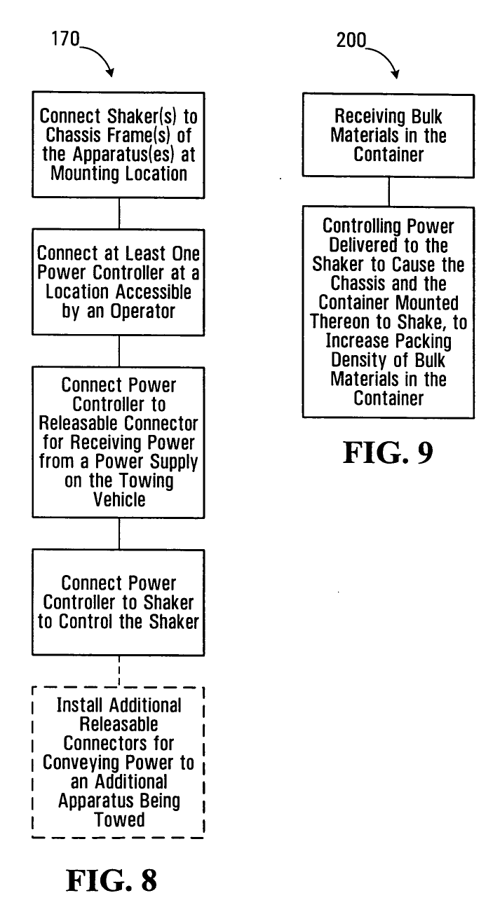

Referring now to FIG. 8, a method of manufacturing the apparatus 12 is shown generally at 170. The method involves a number of steps which need not be necessarily taken in the order shown in FIG. 8. Generally, referring to FIG. 1, the method involves operably connecting the shaker 22 to the wheeled chassis 20 to which is mounted the container 18. The method further involves operably connecting at least one power controller, such as the first and second controls 150 and 160 shown in FIG. 7, in a location accessible by the operator, for example, to the container 18 and/or the chassis 22. The method further involves connecting the power controller to the releasable connector 148 receiving power from the power supply 132. The method also involves connecting the power controller to the shaker 22 to facilitate operator control of power supplied to the shaker. The power controller permits the operator to control power supplied to the shaker 22 and thereby to cause the shaker to shake the chassis 20 and the container 18 mounted thereto, to increase packing density of bulk materials in the container.

Referring to FIG. 1, connecting the shaker 22 to the wheeled chassis 20 may involve connecting the shaker 22 to at least one of a longitudinal or transverse beam (e.g., 24 or 50) of the chassis as shown in FIG. 2. This may involve welding the base 70 of the shaker 22 to a mount supported by the beam. The mount includes the plate 64 or 65 in this embodiment. Since the first apparatus 12 is coupled to tow the second apparatus 14, manufacture of the apparatus 12 may further involve installing an additional connector such as 156 on the apparatus 12 in order to supply power to a complementary connector such as 158 connectable thereto on the second apparatus 14, for powering the second shaker 222 on the second apparatus 14. In the case of the first apparatus 12, this latter step of manufacturing may be unnecessary if no additional container is to be towed behind the first apparatus 12.

Referring to FIG. 9, a method of densifying bulk materials for transport is shown generally at 200. The method involves causing the container 18 to shake in response to actuation of the shaker 22 mounted on the wheeled chassis 20, on which the container is mounted, while causing bulk materials to be received in the container. The method further involves facilitating receipt and storage of the bulk materials in the drop bed portion 123 of the container 18. Causing the container 18 to shake involves controlling power supplied to the shaker 22, which, in this embodiment involves actuating the switch 152 of the control 150 to selectively supply power to the shaker. Similarly, bulk materials in the second apparatus 14 are densified for transport by operation of the shaker 22 in response to user actuation of the second control 160.

It has been found that the embodiments and methods described herein may be capable of increasing the effective capacity of a wood chip transportation system by about 15% in some cases by densifying, i.e., increasing the packing density of, wood chips in the container 18. Moreover, the approach described tends to cause wood chips to automatically spread within the container 18 during loading thus reducing the need for the operator to climb on top of the container 18 to groom the crown of the load to fill unused space in the container. This increases the safety and efficiency of the loading operation. Although the exemplary embodiments and methods herein have been described in relation to the densification and transport of wood chips, it should be appreciated that these embodiments and methods may be profitably applied to other types of bulk material cargo as well.

While specific embodiments of the invention have been described and illustrated, such embodiments should be considered illustrative of the invention only and not as limiting the invention as construed in accordance with the accompanying claims.

What is claimed is:

1. An apparatus for densifying and transporting bulk materials, the apparatus comprising:
a container for holding bulk materials;
a wheeled chassis for transporting the container along a roadway;
a shaker, mounted on said wheeled and transportable therewith, for shaking said container while said container is being loaded, to increase packing density of bulk materials in said container.

2. The apparatus of claim 1 wherein said shaker is permanently connected to said chassis.

3. The apparatus of claim 1 wherein said chassis comprises first and second spaced apart longitudinal beams, disposed generally parallel to a longitudinal axis of said chassis.

4. The apparatus of claim 3 wherein said shaker is operably mounted on at least one of said first and second longitudinal beams.

5. The apparatus of claim 3 wherein said chassis further comprises a transverse beam extending between said first and second longitudinal beams wherein said shaker is operably mounted on said transverse beam.

6. The apparatus of claim 5 further comprising a plate extending from said transverse beam, said shaker being operably mounted on said plate.

7. The apparatus of claim 6 further comprising a gusset for reinforcing said plate.

8. The apparatus of claim 1 further comprising a mount, affixed to said chassis, operably configured to mount said shaker to said chassis.

9. The apparatus of claim 8 further comprising a reinforcing member for reinforcing said mount.

10. The apparatus of claim 1 wherein said container comprises:
a plurality of sheet material panels; and
fasteners fastening said plurality of sheet material panels together to form an enclosure.

11. The apparatus of claim 1 wherein said container comprises top, bottom, front, rear and first and second side portions, said top portion having an inlet for receiving bulk materials to be loaded into said container, said rear portion having an outlet for discharging the bulk materials from said container.

12. The apparatus of claim 1 wherein said container comprises an inner floor, a substantial part of which comprises at least one generally planar floor section having a longitudinal axis generally parallel to a longitudinal axis of said chassis.

13. The apparatus of claim 12 wherein said inner floor is continuous.

14. The apparatus of claim 1 further comprising a hitch on said front portion of said container for hitching the apparatus to a vehicle.

15. The apparatus of claim 11 wherein said container comprises a drop-bed portion, between said front and rear portions, said chassis directly supporting said rear portion but not said drop-bed portion.

16. The apparatus of claim 1, further comprising at least one connector for receiving power from a power supply, for actuating the shaker.

17. The apparatus of claim 16 wherein said at least one connector is releasably connectable to a complementary connector on a vehicle, to facilitate separation of said apparatus from said vehicle.

18. The apparatus of claim 16 further comprising a first control operably configured to selectively cause said power supply to supply power through said at least one connector to said shaker when said at least one connector is receiving said power for actuating the shaker.

19. The apparatus of claim 18 wherein said first control is located on said container.

20. The apparatus of claim 18 wherein said container has a recess and said first control is located in said recess.

21. The apparatus of claim 20 wherein said control includes an electrical switch.

22. A system for densifying and transporting bulk materials in a container, the system comprising the apparatus of claim 18 and further comprising a power supply, a second control and a complementary connector, complementary to said at least one connector, said second control being operably configured to selectively cause said power supply to supply power to said complementary connector, for receipt by said at least one connector for actuating the shaker.

23. The system of claim 22 further comprising a signaling device operably configured to provide a signal to an operator when power for actuating the shaker is being supplied to said complementary connector.

24. The system of claim 22 wherein said second control is located in a cab of a vehicle operable to haul said apparatus.

25. The system of claim 23 wherein said signalling device is mounted on a vehicle operable to haul said apparatus.

26. The system of claim 22 wherein said shaker comprises a rotatable shaft, an eccentric weight mounted on said shaft and a motor operable to rotate said shaft in response to power received from said power supply.

27. The system of claim 26 wherein said power supply is selected from the group consisting of an electrical power supply, a hydraulic power supply, and a pneumatic power supply.

28. A method of manufacturing an apparatus for densifying and transporting bulk materials, the method comprising:
operably connecting a shaker to a wheeled chassis on which is mounted a container formed of individual sheet material panels fastened together, for carrying bulk materials;
operably connecting a power controller to at least one of said chassis and said container in a location accessible by an operator;
operably connecting said power controller to at least one releasable connector for receiving power from a power supply associated with a vehicle operable to tow said apparatus;
operably connecting said power controller to said shaker to facilitate operator control of power supplied to said shaker to permit the operator to control said power to cause said shaker to shake said chassis and said container mounted thereto, to increase packing density of bulk material in said container.

29. The method of claim 28 wherein connecting said shaker to said wheeled chassis comprises operably connecting said shaker to at least one of a longitudinal or transverse beam of the chassis.

30. The method of claim 28 wherein connecting a shaker to said wheeled chassis comprises welding a base of said shaker to a mount supported by a transverse beam of the chassis.

31. The method of claim 28 further comprising installing an additional connector on said apparatus, said additional connector being operable to receive at least some power from said at least one connector and to supply said at least some power to a connector connected thereto for powering a second shaker on a second apparatus.

32. An apparatus for densifying and transporting bulk materials, the apparatus comprising:
holding means for holding bulk materials;
transporting means for transporting the holding means along a roadway; and
shaking means, mounted on the transporting means, for shaking the transporting means to impart shaking to the holding means while the holding means is being loaded, to increase packing density of bulk materials held by the holding means.

33. A method of densifying bulk materials for transport, the method comprising:
causing a container operable to hold bulk materials to shake in response to actuation of a shaker mounted on a wheeled chassis on which said container is mounted, while causing bulk materials to be received in said container.

34. The method of claim 33 further comprising facilitating receipt and storage of said bulk materials in a drop bed of said container, wherein said drop bed is located adjacent wheels of said wheeled chassis.

35. The method of claim 33 wherein causing said container to shake comprises controlling power supplied to said shaker.

36 The method of claim 35 wherein controlling power supplied to said shaker comprises actuating a switch to selectively supply power to said shaker.
